(19) United States
(12) Patent Application Publication
(10) Pub. No.: US 2015/0224598 A1
(43) Pub. Date: Aug. 13, 2015

(54) METHOD FOR REPAIRING A TURBOMACHINE COMPONENT

(71) Applicant: NUOVO PIGNONE Srl, Florence (IT)

(72) Inventors: Eugenio Giorni, Florence (IT); Attilio Paolucci, Florence (IT); Fabrizio Mammoliti, Florence (IT); Alessio Andolfi, FLorence (IT); Federico Pineschi, Florence (IT); Riccardo Catastini, Florence (IT)

(21) Appl. No.: 14/426,418

(22) PCT Filed: Sep. 4, 2013
(86) PCT No.: PCT/EP2013/068279

§ 371 Date: Mar. 6, 2015

(30) Foreign Application Priority Data
Sep. 7, 2012 (IT) CO2012A000041

(51) Int. Cl. B23K 26/34; B23P 6/00

(52) U.S. Cl. CPC B23K 26/345; B23P 6/007; B33Y 10/00

(57) ABSTRACT

The method for repairing a turbomachine component comprises the steps of: setting up a laser cladding machine; preparing a portion of a turbomachine component to be repaired by removing a damaged volume of the component; rotating the turbomachine component with respect to the laser cladding machine; rebuilding the damaged volume by laser cladding in order to obtain a rebuilded volume in the damaged component; applying a heat treatment to the rebuilded volume of the turbomachine component; finishing a surface of the rebuilded volume; non-destructively testing the rebuilded volume; wherein the step of setting up the laser cladding machine includes some sub-steps for defining the parameters to operate said rebuilding phase.

### BACKGROUND OF THE INVENTION

The present invention relates to method for repairing a turbomachine component by laser-cladding.

The increasing use of turbomachines to the operational limits requires the development of specific repair technologies designed to reproduce conditions close to those of new parts. Both rotating and non-rotating parts are subject to damages due to erosion and/or to wear.

For example, steam turbine shafts are often damaged in coupling areas at shaft ends and in journal bearing areas. On centrifugal compressor shafts the same situation occurs for bearing journals and for the shaft ends, while very often during compressor overhaul; impellers are found with the sealing area worn out. Other rotary or stationary parts can be damaged as well, such as steam turbine blades, centrifugal compressor cases, or gas turbine rotors.

In the above field, conventional repairing techniques, such as electric arc or microplasm deposit welding, show a plurality of disadvantages, i.e., in particular, high heating and cooling rates and low melting volumes. As an alternative, repairing methods by laser surfacing are known. Advantages of the latter over alternative surfacing processes include:
Chemically cleanliness, as combustion or ion bombardment are not involved,
Localized heating with minimum heat transfer to the substrate, resulting in minimal thermal damage for the component,
Reduced post-machining procedures,
Possibility to process very hard, brittle, or soft materials,
Possibility to control heat penetration,
Possibility to deposit thicker layers.

Among laser surfacing methods, laser cladding is generally known. Laser cladding uses a laser beam to fuse a cladding material having desired properties into the base material of a component whose surface is to be repaired. Laser cladding offers the possibility to create surface layers with superior properties in terms of pureness, homogeneity, hardness, bonding, and microstructure.

Laser cladding repairing methods are already used to repair stationary components, as described in US20100287754, or to deposit small volumes of cladding material, as described in US20090057275.

To repair larger and thicker damaged areas and/or surfaces of rotary components, the method parameters have to be properly tuned in order to optimally restore the aspect and properties of the damaged components. In particular, it has to be solved the conflict between the demand of achieving a good metallurgical bond, necessary to rebuild damaged parts, and avoiding mixture between the coating and the base material in order to have desired coating properties on the surface. In general, the right correlation between all the variables of the process has to be found.

It would be therefore desirable to provide an improved laser cladding method which permits to find such a correlation in an easy and reproducible way for each turbomachine component to be repaired, in order to avoid the inconveniencies of the known prior arts.

### SUMMARY

According to a first embodiment, the present invention accomplish such an object by providing a method for repairing a turbomachine component comprising the steps of:
setting up a laser cladding machine;
preparing at least a portion of a turbomachine component to be repaired by removing a damaged volume of said component;
rotating one of said laser cladding machine and turbomachine component with respect to the other of said laser cladding machine and turbomachine component
rebuilding said damaged volume by laser cladding in order to obtain a rebuilded volume in said component;
applying a heat treatment to at least said rebuilded volume of said turbomachine component;
finishing a surface of said rebuilded volume;
non-destructively testing said rebuilded volume.

According to a further advantageous feature of the first embodiment, the step of setting up the laser cladding machine includes the sub-steps of:
identifying a set of laser cladding process parameters,
identifying a sample;
welding a first layer on said sample by said laser cladding machine after imposing said set of laser cladding process parameters;
comparing a plurality of geometric data of the first layer with a respective plurality of reference data range;
if said plurality of geometric data are within said plurality of reference data ranges, welding a plurality of further layers on said sample by said laser cladding machine;
testing said plurality of further layers by micrographic inspection for defining the parameters to operate said rebuilding phase.

According to a further advantageous feature of the first embodiment, the plurality of geometric data includes:
at least an angle (α) between an edge of said first layer and a surface of said sample, having a value of 150° to 160°;
the height of said first layer,
the width of said first layer,
the ratio between said width and said height of said first layer being greater than 5.

With respect to other known repairing methods, the solution of the present invention allows to:
easily find the correct correlation between the laser cladding parameters for each turbomachine component to be repaired,
efficiently rebuild greater damaged volume, by depositing layers of cladding materials up to a thickness of 6 mm, without diminishing the mechanical properties of the repaired component.

In a second embodiment, the present invention provides a mobile apparatus for repairing a turbomachine component comprising a turning machine and a laser cladding device of the type including a laser device for creating a laser beam and a powder feeder device for blowing a metal powder towards said laser beam, characterized in that said laser cladding device is fixable to a tool station of said turning machine.

The same advantages described above with reference to the first embodiment of the present invention are accomplished by this second embodiment. In addition, the latter embodiment permits to perform the method of the present invention directly on site, without requiring the whole turbomachine or the components to be repaired to be moved away.

### BRIEF DESCRIPTION OF THE DRAWINGS

Other object feature and advantages of the present invention will become evident from the following description of the embodiments of the invention taken in conjunction with the following drawings, wherein:

FIGS. 1 is a general block diagram of a method for repairing a turbomachine, according to the present invention;

FIG. 2 is a detailed block diagram of the method in FIG. 1;

FIGS. 3A, 3B, 4B, and 4C are detailed block diagrams of embodiments of the method in FIG. 1 respectively corresponding to different components of a turbomachine;

FIG. 5 is a block diagram of a portion of the method in FIG. 1;

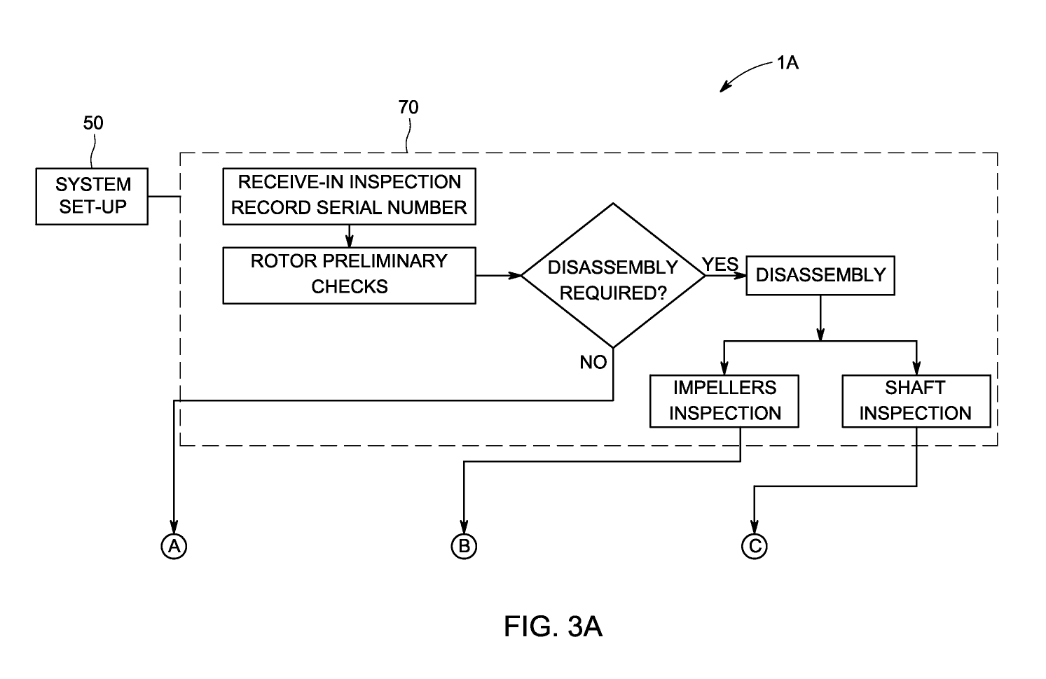

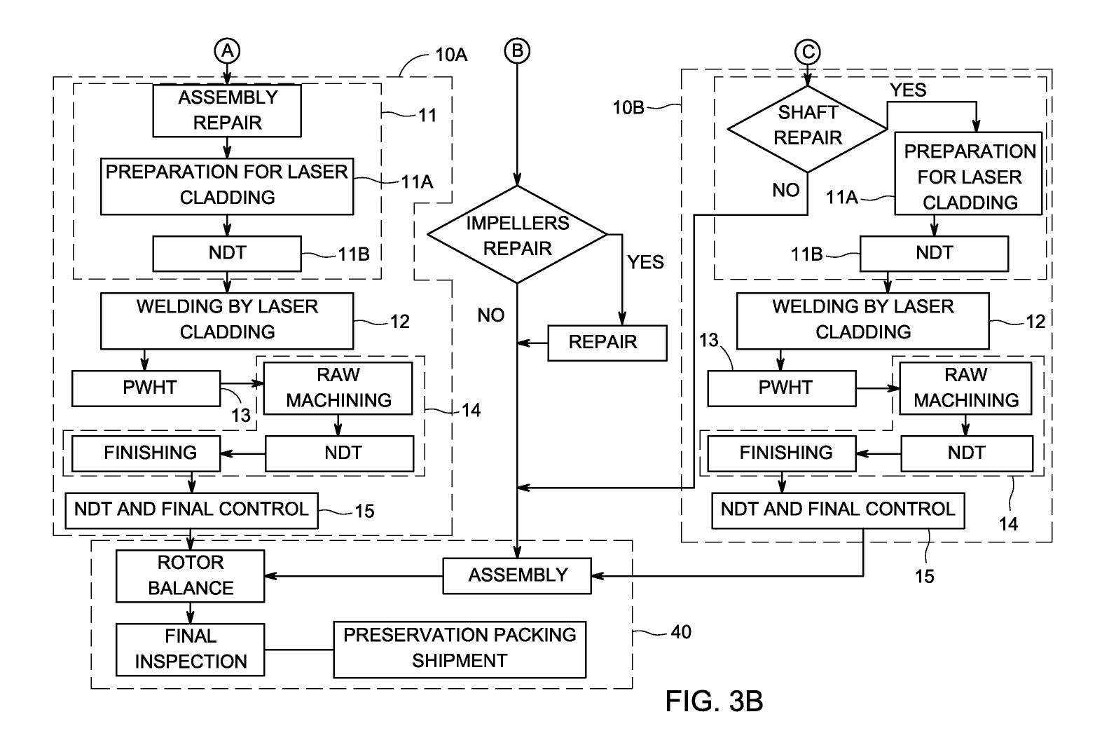

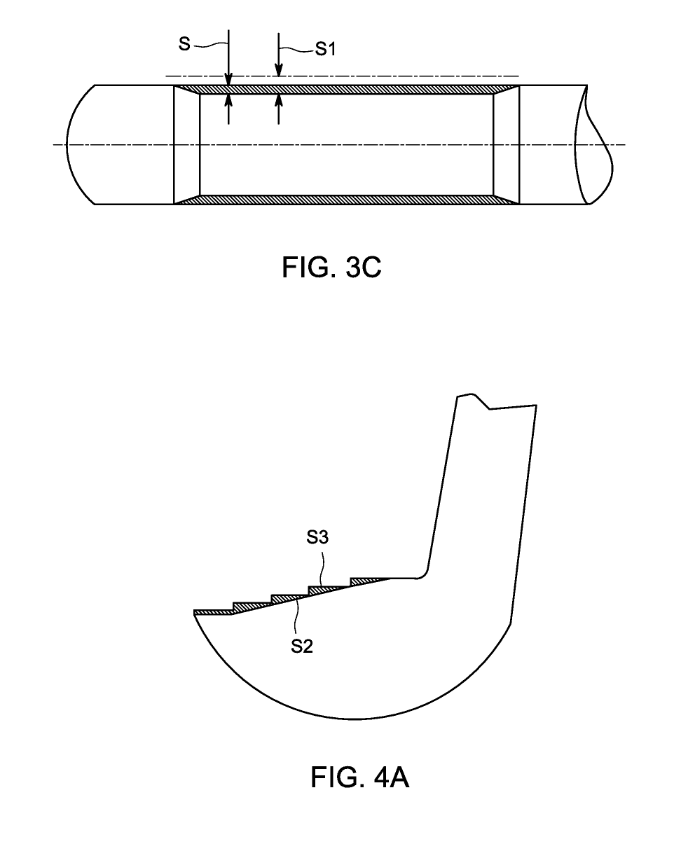

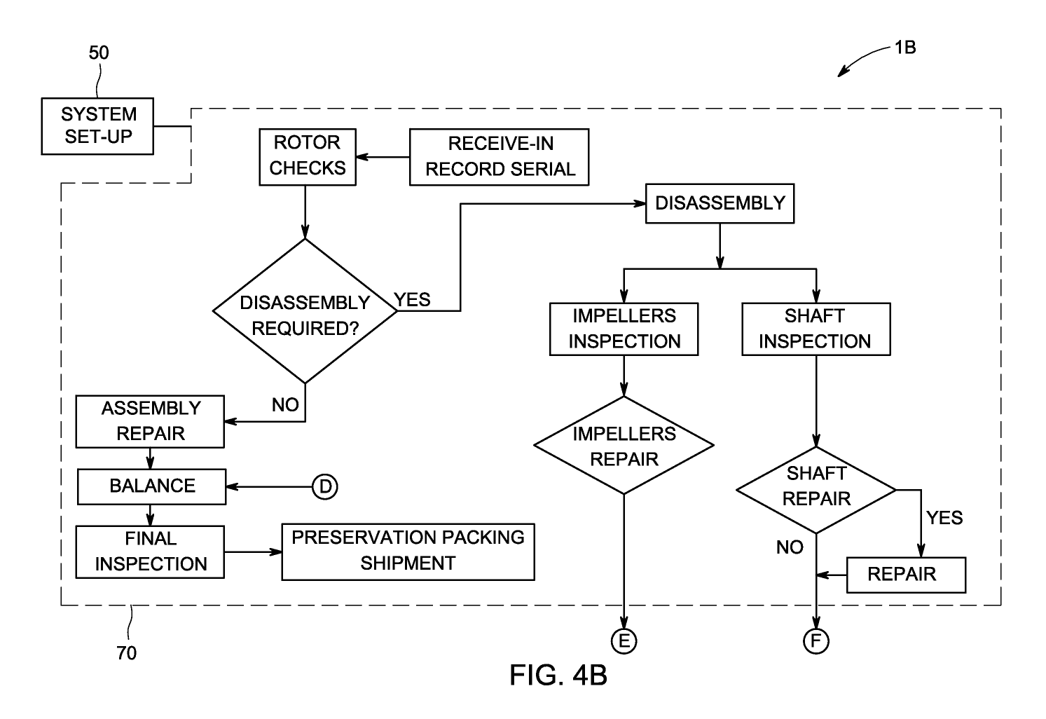

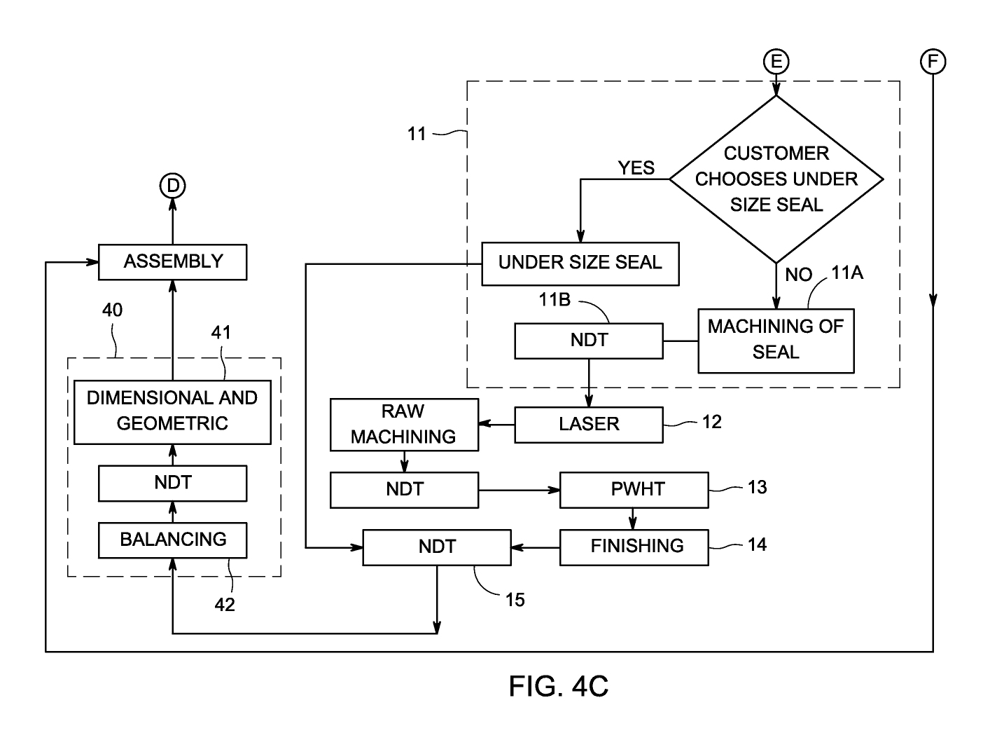

FIGS. 3C and 4A are detailed side views of two turbomachine components to which the embodiments of the method in FIGS. 3A, 3B, 4B, and 4C are respectively applicable;

FIGS. 6, 7, 8, 9, 10, 11, and 12 are perspective views of an apparatus for repairing a turbomachine, according to the present invention, in different operating conditions.

### DETAILED DESCRIPTION OF THE INVENTION

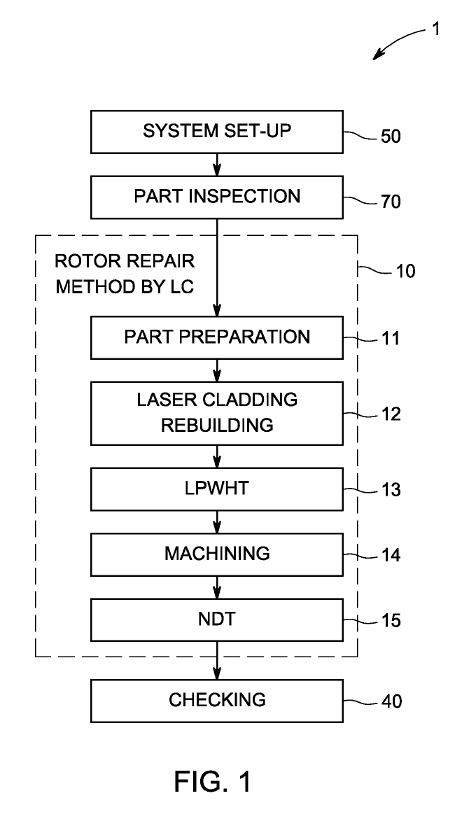

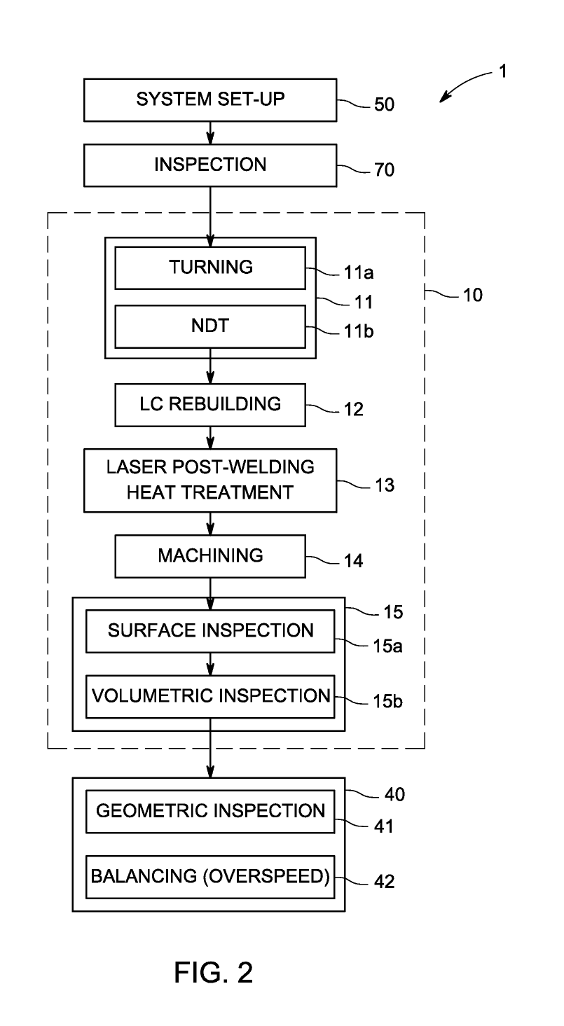

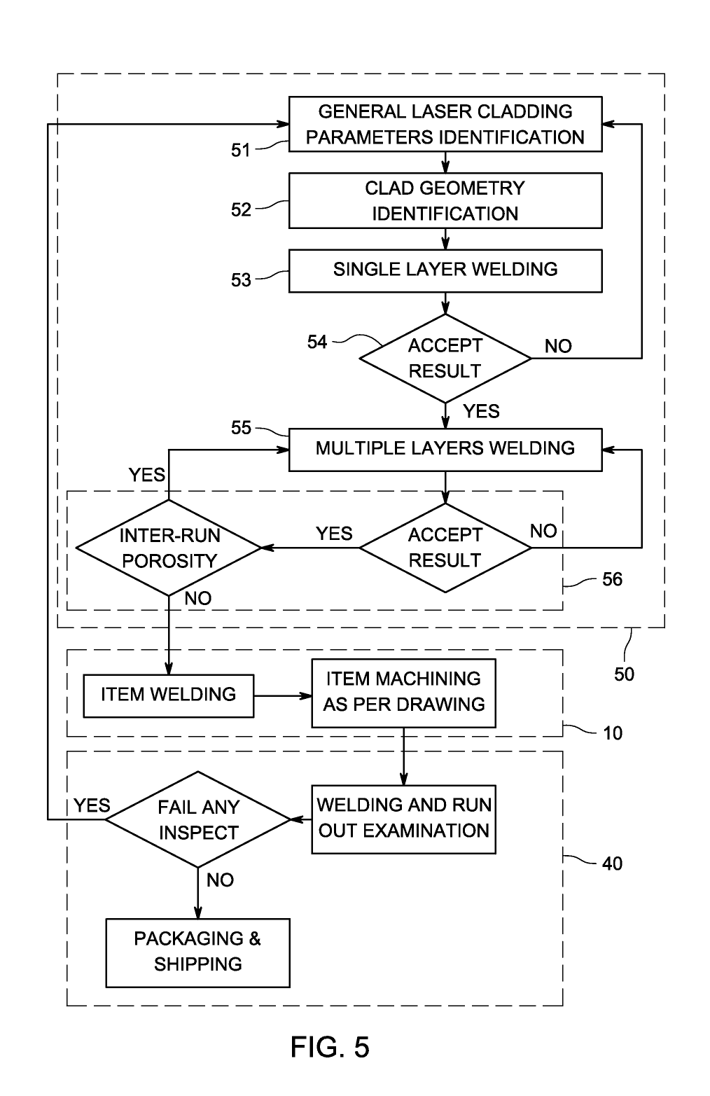

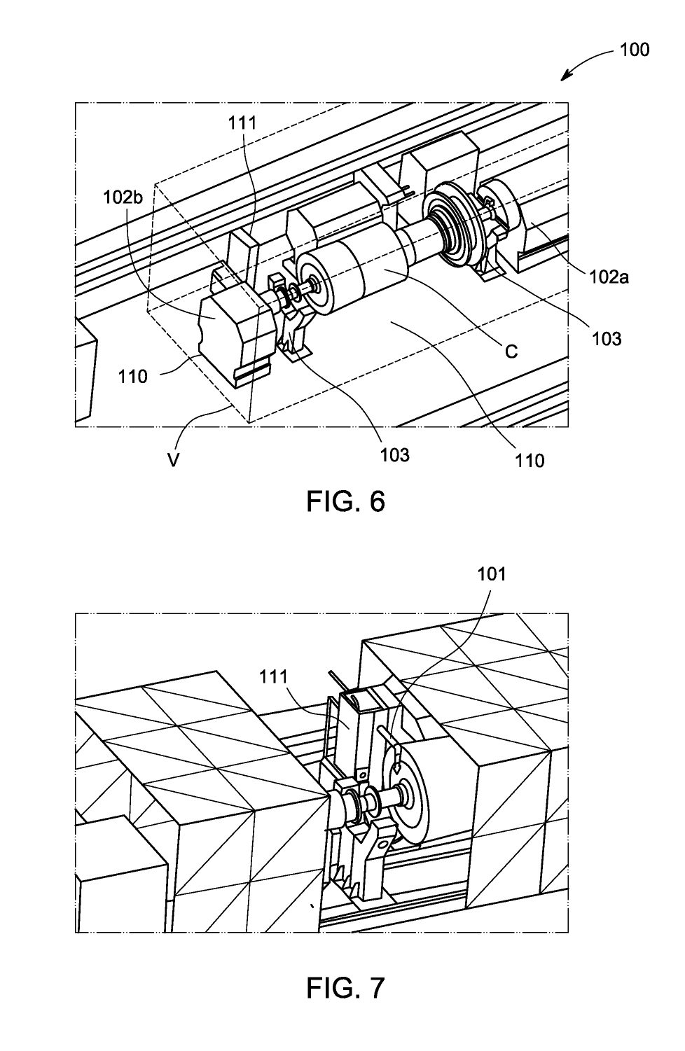

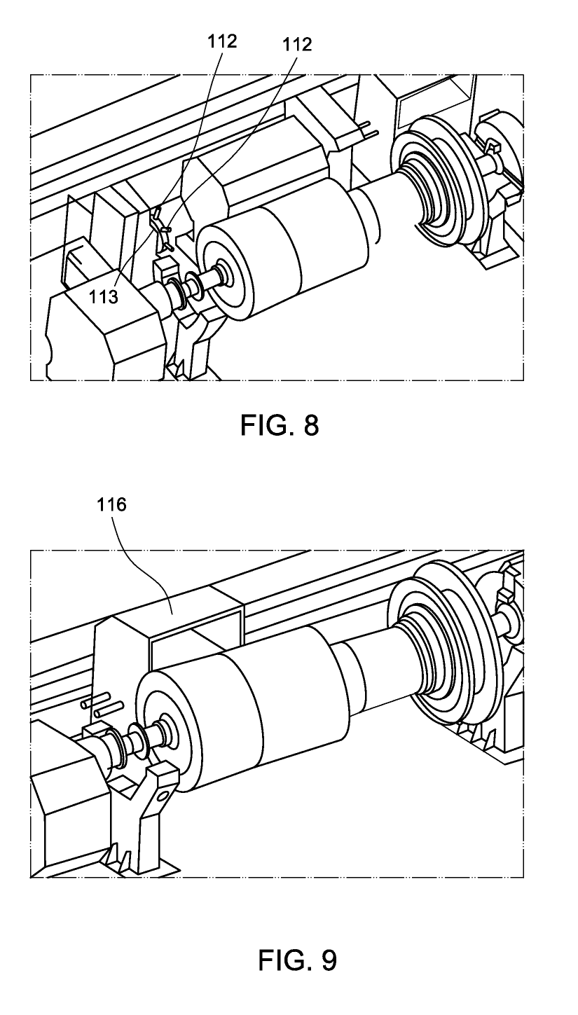

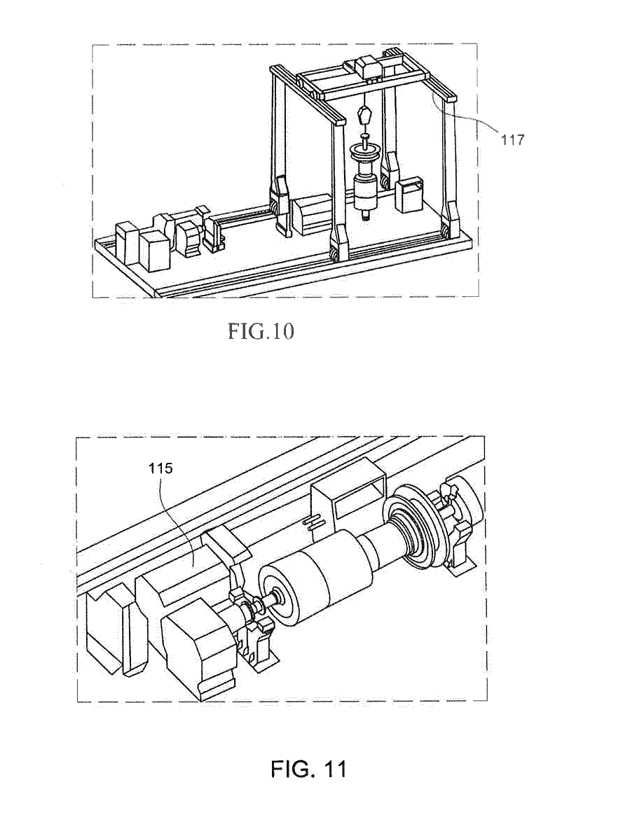

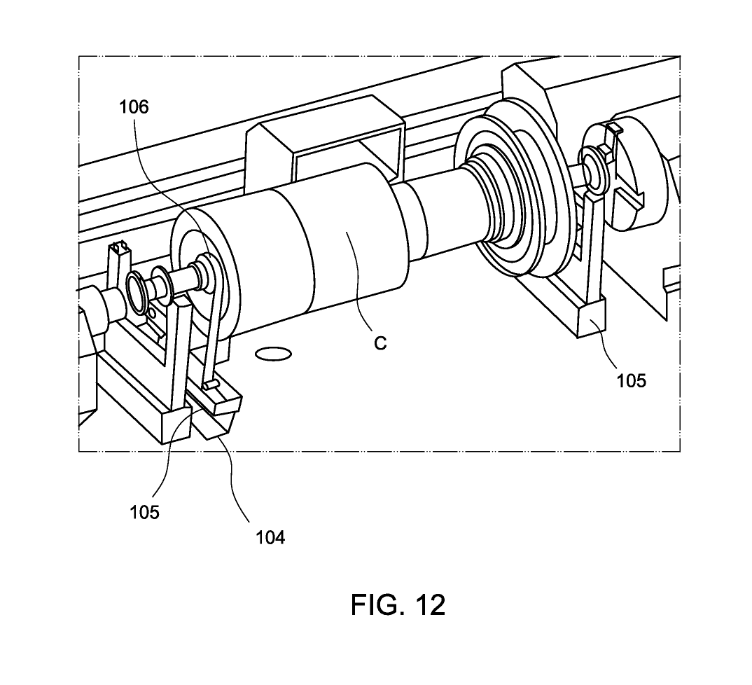

With reference to the attached FIGS. 1-5, a method for repairing a turbomachine component C is overall indicated with 1.

The method 1 comprises a first step 50 of setting up a laser cladding machine 100 (i.e. an “apparatus”), including a laser beam device 101 (i.e. a “laser cladding device”) and a powder feeder.

The laser beam device 101 is of a conventional type, for example Rofin YAG laser, 2.2 kW or IPG fiberlaser, 2.2 kW. In general, for the purposes of the present invention, other laser beam devices can be used provided that a uniform power density is reached in order to obtain an acceptable uniform temperature distribution and consistent clad properties over the width of the laser track.

With reference to FIG. 6-12, the laser cladding machine 100 includes:
a lathe 102, having a main body 102a and a tailstock body 102b;
a pair of supports 103, for supporting the component C to be repaired between the main body 102a and the tailstock body 102b of the lathe. In the embodiment in FIG. 6 the component C is the rotary shaft of a turbocompressor, including a plurality of impellers mounted thereof. The present invention can be used for repairing the journal bearing region or the impellers in a rotary shaft. In general the present invention is adaptable for repairing a plurality of component in a plurality of regions subject to erosion or corrosion or wear;
a balancing device 104, including pair of balancing supports 105, each having a wrap around belt 106, for balancing the component C;
a pair of guides 110, wherein the tailstock body 102b and the supports 103, 104 are mounted in such a way to be aligned with the main body 102a of the lathe. The tailstock body 102b and the supports 103, 104 are movable along guides 110 towards the the main body 102a or away from it.

With reference to FIG. 6-12, the laser cladding machine 100 further includes:
a tool station 111, wherein the laser beam device 101 is mounted. A plurality of turning tools 112, arranged in a circular tool holder 113, are also mounted on the tool station 111, which therefore can be used as a machining station and also as a laser cladding station;
a grinder 115, for surface finishing after cladding;
an horizontal post-welding heat treatment station 116, for heat treating the component C after repairing by laser cladding has been executed.

The tool station 111, grinder 115 and post-welding heat treatment station 116 are movable parallel to the guides 110 in various configurations, as detailed further above.

The laser cladding machine 100 is also configurable in order to be completely housed in a limited volume V, suitable for transportation by truck, in particular a standard shipping container.

The first step 50 of setting up the laser cladding machine includes a first sub-step 51 of identifying a set of laser cladding process parameters.

The process parameters, with relevant ranges, include:
powder rate: 1.5 to 6 g/min,
laser beam power PS: 900 to 1500,
scanning speed v: 2 to 10 mm/s,
stand-off distance (i.e. distance between the nozzle of the powder feeder and the part to be repaired): 11 to 15 mm,
cover gas flow rate: 8 to 101/min,
powder mesh: 45 to 105 micron,
energy density E: 110 to 120 J/mm2.

The powder type is chose among Inconel 625, Stellite 21 or ASTM A 322 type 4140.

The above parameters have to be correctly tuned depending on the type and geometry of the component to be repaired, on the specific laser cladding machine which is used to perform the repairing operations and on the environment, for example room temperature and humidity.

For example the latter has influence on the choice of powder mesh. First tentative values are defined first sub-step 51 in the first sub-step 51 by applying the procedure which follows, based on relations A1, A2, A3, A4.

Energy density is defined as

E=PS·It, (A1)

where

PS=PL/Aw (A2)

is the specific power and

It=dS/v (A3)

is the interaction time process. Aw and dS are, respectively, welding area and spot welding diameter, depending on the geometry of the region to be repaired and of the laser cladding device 101, for example optics, i.e. lenses and focal length of the laser cladding device.

By combining together the above relations A1, A2 and A3, the following expression for E is obtained:

E=(PL·ds)/(Aw·v) (A4)

In the above, the PL, ds, Aw, and v have to be tuned in order to limit the energy density between 110 and 120 J/mm2. Scanning speed v is to tuned between 2 and 10 mm/s, in order to avoid high thermal residual stresses.

The first step 50 of setting up the laser cladding machine includes a second sub-step 52 of identifying a sample, for example a cylinder of the same material of the component to be repaired.

In a third sub-step 53 of the first step 50, a first layer is welded on the sample by the laser cladding machine 100 after imposing a set of the above laser cladding process parameters.

In a fourth sub-step 54 of the first step 50, a plurality of geometric data of the first layer is compared with a respective plurality of reference data ranges.

Geometric data includes:
an angle α between an edge of the first layer and a surface of said sample;
the height of the first layer,
the width of the first layer,
the depth of penetration of the layer,
width or depth of the first layer heat affected zone.

Reference data ranges are:
Energy density E between 110 and 120 J/mm2
clad aspect ratio (width/height) greater than 5;
angle α included between 150° and 160°.

If the plurality of geometric data is within the specified ranges, the first step 50 of the method 1 continues with fifth sub-step 55 of welding a plurality of further layers on the sample by the laser cladding machine 100.

In a sixth sub-step 56, the plurality of further layers is tested by micrographic inspection, including examining inter-run porosity, wherein the reference parameter is an overlap parameter defined as clad width percentage of overlap.

If the plurality of geometric data are outside the plurality of reference data ranges, the first step 50 of setting up the laser cladding machine 100 includes the further sub-step of modifying said set of laser cladding process parameters. For example, if the angle α is greater than said respective angle range than the powder rate is reduced. In general all parameters are inter-correlated, therefore a correct set have to be defined considering all of them. After changing the process parameters the third and fourth sub-step 53, 54 are repeated.

In order to carry out the set-up of the laser cladding machine 100, in particular the laser beam device 101, one or (typically) more accessories are used; the laser cladding machine 100 is advantageously provided and shipped with these accessories.

The method 1 comprises a second step 70 of inspecting the turbomachine component to be repaired.

After the second step 70, the method 1 includes a group 10 of repairing steps 11, 12, 13, 14. The group of repairing steps 11, 12, 13, 14 includes:
a third step 11 of preparing a portion of the turbomachine component C to be repaired by removing a damaged volume of said component by a turning sub-step 11a (FIG. 8). When repairing journal bearing, a circumferential groove (FIG. 3C) has to be created, having a depth S depending on the amount of material to be deposited in the following step, by laser cladding. After the turning sub-step 11a a subsequent sub-step 11b of non-destructive testing the portion prepared in the previous sub-step 11a is performed in order to verify that all damaged portion of the turbomachine component C has been removed. After preparing the portion to be repaired the component C is again rotated with respect to laser cladding machine 100, in order that the round geometry of the turbomachine component C can be repaired without moving laser beam device 101;
a fourth step 12 of rebuilding the damaged volume by the laser beam device 101 in order to obtain a rebuilded volume in the component C (FIG. 7). In the fourth step 12, the laser beam device 101 is operated according to the parameters define in the first set-up step 50;
a fifth step 13 of applying a heat treatment to the rebuilded volume of the turbomachine component C. The heat treatment can be applied horizontally, by using the heating station 116 (FIG. 9) or vertically, by using the crane 117 (FIG. 10). Vertical heat treatment are, in an embodiment, for long components, e.g. shafts;
a sixth step 14 of finishing a surface of the rebuilded volume by further turning and then, optionally, in the case of journal bearing repair, grinding by grinder 115 (FIG. 11);
a final step 15 of inspecting the surface and the inside of the rebuilded volume.

The final step 15 comprises:
a first sub-step 15a of testing the surface of the rebuilded volume by dye penetrant inspection and, optionally, in the case of journal bearing repair,
a second sub-step 15b of testing an inner portion of said rebuilded volume by eddy current inspection.

At the end of the method 1, the step 15 is followed by a further step 40 of finally checking the turbomachine component C, including a dimensional and geometric check 41 and a balancing sub-step 42, by using the balancing device 104.

In an embodiment 1a (FIG. 3A and 3B), the method of the present invention is applied to the journal bearing region (FIG. 3C) of the rotary shaft of a turbomachine, e.g. a turbocompressor. The method 1a comprises the first step 50 of setting up the laser cladding machine, as above described and the second step 70 of inspecting the rotary shaft of the turbomachine to be repaired. During the second step 70, preliminary checks are performed in order to decide if disassembly of the rotary shaft, i.e. disassembly impellers from shaft, is required for repairing the journal bearing region or if disassembly of the rotary shaft is not necessary. In the latter case the journal bearing region is to be repaired without disassembling the impellers and the method 1a continues with the group 10a of repairing steps, including:
the third step 11 of preparing the trapezoidal circumferential groove (FIG. 3C) having a depth S depending on the amount of material to be deposited in the following fourth step 12. The third step 11 includes the sub-step 11a of turning the journal bearing region for creating the trapezoidal circumferential groove and the sub-step 11b of non-destructive testing the groove obtained in the previous sub-step 11a for verifying that the damaged portion of the journal bearing region has been completely removed;
the fourth step 12 of rebuilding the damaged volume by filling the trapezoidal circumferential groove with the laser beam device 101 by depositing one or more layers of material having an overall thickness S1, greater than S;
the fifth step 13 of applying a heat treatment to the repaired rotary shaft;
the sixth step 14 of finishing the surface of the rebuilded volume by first raw machining, then non-destructive testing and finally grinding by grinder 115 (FIG. 11);
the final step 15 of testing both the surface and the inside of the rebuilded volume by applying, respectively, the sub-steps 15a,b of dye penetrant inspection and eddy current inspection.

In the case that preliminary checks of the second step 70 identify that disassembly of the rotary shaft is required, method 1a continues with a disassembly step by which the impellers are disassembled from the shaft and with a group 10b of repairing steps, including the same steps of the group 10a. Differently from the group 10a, the group of steps 10b is applied on the shaft. At the end the final step 15 of testing the impellers and the repaired shaft are again assembled.

Both groups of steps 10a and 10b are in the end followed by the step 40 of finally checking the turbomachine component C, including first the balancing sub-step 42, performed for example by using the balancing device 104, and then the dimensional and geometric check 41.

In another embodiment 1b (FIGS. 4B and 4C), the method of the present invention applied to an impeller eye seal region of a turbomachine (FIG. 4A), e.g. an impeller of a turbocompressor. The method lb comprises the first step 50 of setting up the laser cladding machine, as above described, and the second step 70 of inspecting the impeller eye seal region of the turbomachine to be repaired. During the second step 70, impellers are disassembled from shaft. If necessary, the shaft is also repaired, for example by using the embodiment 1a above described. After the second step 70 the method lb continues with the group 10 of repairing steps, including:
the third step 11 of preparing a smooth conical surface S2 in the impeller eye seal damaged region (FIG. 3C). The third step 11 includes the sub-step 11a of turning the impeller for creating conical surface S2 and the sub-step 11b of non-destructive testing the surface obtained in the previous sub-step 11a for verifying that the damaged volume has been completely removed;
the fourth step 12 of rebuilding the damaged volume by re-creating the stepped eye seal region S3 with the laser beam device 101;
the fifth step 13 of applying a heat treatment to the repaired impeller;
the sixth step 14 of finishing the rebuilded volume stepped eye seal region S3 by turning;
the final step 15 of testing the surface of the eye seal region S3 by applying dye penetrant inspection.

The group of steps 10 is in the end followed by the step 40 of finally checking the turbomachine component C, including first the balancing sub-step 42, performed by rotating the impeller till overspeed conditions are reached, and final geometric check 41.

In general, many other turbomachine components can be repaired with the method of the present invention by using a laser cladding machine as above described.

In all cases it is essential that the laser cladding process parameters are correctly defined by correctly applying the set up step 50, thus allowing to accomplish the object and advantages cited above.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

What is claimed is:

1. A method for repairing a turbomachine component, the method comprising:
setting up a laser cladding machine;
preparing at least a portion of a turbomachine component to be repaired by removing a damaged volume of the turbomachine component;
rotating one of said laser cladding machine and the turbomachine component with respect to the other of the laser cladding machine and the turbomachine component;
rebuilding the damaged volume by laser cladding in order to obtain a rebuilded volume in the turbomachine component;
applying a heat treatment to at least the rebuilded volume of the turbomachine component;
finishing a surface of the rebuilded volume; and
non-destructively testing the rebuilded volume,
wherein setting up the laser cladding machine comprises:
identifying a set of laser cladding process parameters;
identifying a sample;
welding a first layer on the sample by the laser cladding machine after imposing the set of laser cladding process parameters;
comparing a plurality of geometric data of the first layer with a respective plurality of reference data range;
if the plurality of geometric data are within the plurality of reference data ranges, welding a plurality of further layers on the sample by the laser cladding machine; and
testing the plurality of further layers by micrographic inspection for defining parameters to operate the rebuilding phase.

2. The method according to claim 1, wherein the step of preparing is preceded by a further step of inspecting the turbomachine component to be repaired.

3. The method according to claim 1, wherein non-destructively testing comprises:
testing the surface of the rebuilded volume by dye penetrant inspection; and
testing an inner portion of the rebuilded volume by eddy current inspection.

4. The method according to claim 1, wherein the step of non-destructively testing is followed by a further step of finally checking the turbomachine component.

5. The method according to claim 1, wherein the laser cladding machine comprises a laser device configured to create a laser beam,. and a powder feeder device configured to blow a metal powder towards the laser beam.

6. The method according to claim 1, wherein the set of laser cladding process parameters comprises:
powder rate;
laser beam power;
powder type;
scanning speed;
stand-off distance;
cover gas flow rate;
powder mesh; and
energy density.

7. The method according to claim 1, wherein the set of laser cladding process parameters comprises energy density, and the energy density is between 110 and 120 J/mm².

8. The method according to claim 1, wherein the plurality of geometric data comprises:
at least one angle between an edge of the first layer and a surface of the sample;
a height of the first layer, the a width of the first layer.

9. The method according to claim 8, wherein the plurality of geometric data have to be included in a plurality of reference data ranges comprising:
a ratio between the width and the height of the first layer, the ratio is greater than 5, and
a range of the at least one angle between the edge of the first layer and the surface of the d sample, the range of the at least one angle is 150° to 160°.

10. The method according to claim 9, wherein, if the plurality of geometric data are outside of the plurality of reference data ranges, setting up the laser cladding machine further comprises:
modifying the set of laser cladding process parameters;
welding the first layer on the sample by the laser cladding machine after changing the set of laser cladding process parameters; and
comparing the plurality of geometric data of the first layer with the respective plurality of reference data ranges.

11. The method according to claim 9, wherein, if the at least one angle is greater than the range of the at least one angle, then the powder rate is reduced.

12. The method according to claim 1, wherein testing the plurality of further layers by micrographic inspection comprises examining inter-run porosity.
